(19) United States
(12) Patent Application Publication
(10) Pub. No.: US 2026/0110334 A1
(43) Pub. Date: Apr. 23, 2026

(54) TORQUE TUBE INTERFACE WITH BIFURCATED STOP

(71) Applicant: ARRAY TECH, Inc., Albuquerque, NM (US)

(72) Inventors: Shuo Chen, Chandler, AZ (US); Nathan Schuknecht, Golden, CO (US); Kevin Krautbauer, Phoenix, AZ (US); Benjamin C. De Fresart, Chandler, AZ (US); Ayman Hangalay, Laveen, AZ (US)

(21) Appl. No.: 19/360,310

(22) Filed: Oct. 16, 2025

Related U.S. Application Data
(60) Provisional application No. 63/710,723, filed on Oct. 23, 2024.

(51) Int. Cl. F16C 35/02; H02S 20/20

(52) U.S. Cl. CPC F16C 35/02; H02S 20/20

(57) ABSTRACT

A torque tube interface for securing a torque tube to a support pile in a photovoltaic system may include a bearing housing configured to be secured to a support pile. The bearing housing may define an aperture and a housing slot. The torque tube interface may also include a bearing, which may be positioned substantially within the aperture such that the bearing is able to rotate within the bearing housing. The torque tube interface may also include a bifurcated stop which includes a first ring portion and a second ring portion that may connect and define an enclosed ring that may be secured around a torque tube and positioned at least partially within the bearing housing. The bifurcated stop may also include a limiter that is configured to extend through the housing and bearing slots to limit the amount that the torque tube may rotate.

### CROSS-REFERENCE TO RELATED APPLICATIONS

This patent application claims priority to and the benefit of United States Provisional Patent Application Ser. No. 63/710,723, entitled TORQUE TUBE INTERFACE WITH BIFURCATED STOP, filed Oct. 23, 2024, which is incorporated by reference in its entirety.

### FIELD

The present disclosure relates to solar energy production and more particularly to a torque tube interface with a bifurcated stop for securing a torque tube to a support pile in a photovoltaic (PV) system.

### BACKGROUND

Each of the PV modules in solar panel systems may be attached to a support structure, or pile. The PV modules may be mounted in rows on solar trackers that direct an orientation of the PV modules such that the angle of the PV modules with respect to the support structure changes throughout the day. Changing the angle of the PV module with respect to the support structure enables the PV module to track the location of the Sun and maximize efficiency. Often, a large number of PV modules are mounted to a single torque tube, which is secured to one or more piles or other support structures, through one or more torque tube interfaces. Torque tube interfaces often include both a bearing and bearing housing. The bearings are often configured to rotate with the torque tube within the bearing housing.

While a limited amount of rotation is desired in order to allow the PV modules to track the location of the Sun in the sky, solar trackers also seek to prevent torque tubes from over rotating or rotating beyond what the tracking system is designed to allow. However, as a torque tube is rotated away from a balanced horizontal position, the amount of rotational force that results from overhanging weight of PV modules increases. The torque generated from this overhanging weight may be substantial and may be significant at the rotational limits of the tracking system. Over time, this torque can cause damage to the motor, gears, and other components of the tracking system. Damage to these components is often expedited by external factors and forces such as wind, snow accumulation on the PV modules, and seismic activities, which may create additional rotational torque on the tracking system.

In order to prevent over-rotation of the torque tube, a torque tube interface may include a stop component that physically prevents a torque tube from rotation beyond a designed amount. For example, the stop may be configured to lock, cease, or limit rotation of the torque tube and PV modules beyond a certain angle. Thus, a stop may prevent over-rotation or rotation outside of the operational range of the tracking system.

Due to a variety of contributing factors, including the weight of the PV modules mounted to a single torque tube, seismic activity, and environmental conditions such as wind and snow accumulation, a large amount of stress may be placed on torque tube interfaces and the stops within them. This stress may lead to failure, breakage, and the need to repair or replace the stops. Typically, stops are unitary structures that cannot be separated into multiple pieces. Thus, in order to install, replace, repair, or remove these stops, the stops must be slid over one end of the torque tube.

Stops that have unitary structure designs may lead to significant inefficiencies and costs. For example, replacing a damaged stop that is in the middle of a line of PV modules on a torque tube would require removing all of the PV modules and torque tube interfaces between the damaged stop and one end of the torque tube so that a new stop may be threaded through the torque tube and back to the location of the torque tube interface with the damaged stop. This process also requires the PV modules and torque tube interfaces to be reinstalled, which creates a risk for error in the reinstallation process.

Additionally, current stops utilize non-ferrous metals like aluminum, which, in some circumstances, may fracture under the torsional loads the stop may experience due to the rotation of the torque tube. Stops constructed out of these metals may also demonstrate a higher wear-rate which may result in some surfaces of the stop being eroded due to the frictional forces between the stop and the bearing housing as the torque tube rotates. As a result, the stop may be less effective at controlling and/or limiting the rotation of the torque tube, which in turn may damage components of the tracking system and/or make the solar tracker less effective at tracking the location of the Sun in the sky.

Accordingly, there is a need for an improved torque tube interface that includes a stop that can be installed and removed without requiring any other components in the solar panel system to be removed and reinstalled. There is also a need for a more durable and robust stop that may withstand torsional and impact forces without fracturing and that may exhibit a lower-wear rate.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used to limit the scope of the claimed subject matter.

Exemplary embodiments of the present disclosure address problems experienced in solar panel tracking systems, including problems associated with the inefficiencies created by stops that have unitary structure designs. Embodiments disclosed herein address this issue by providing a bifurcated stop that includes a first ring portion, a second ring portion, and a limiter. By separating the stop into multiple pieces, the stop may be removed from a torque tube and repaired or installed without the need to slide the stop over an end of the torque tube. In some embodiments, the stop may be constructed out of steel, cast-iron, rubber, plastic, or another high strength and durable material in order to reduce the potential of fracturing due to torsional loads and to reduce the wear-rate experienced by the stop as the torque tube rotates.

Thus, the embodiments disclosed may improve solar panel tracking systems by allowing stops to be replaced, repaired, and reinstalled without removing all of the PV modules in a line of PV modules or other components in the system. Embodiments disclosed herein may also increase the life of stops by manufacturing the stops out of a higher strength material.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the accompanying drawings in which:

FIG. 1 illustrates an example system for mounting PV modules;

FIG. 2A illustrates a perspective view of an example torque tube interface;

FIG. 2B illustrates an exploded view of the example torque tube interface;

FIG. 3A illustrates a perspective view of an example bifurcated stop;

FIG. 3B illustrates an exploded view of the example bifurcated stop;

FIG. 4A illustrates a perspective view of another example bifurcated stop;

FIG. 4B illustrates an exploded view of the example bifurcated stop in FIG. 4A.

FIG. 5A illustrates a perspective view of another example bifurcated stop; and

FIG. 5B illustrates an exploded view of the example bifurcated stop in FIG. 5B.

All in accordance with one or more embodiments in the present disclosure.

### DETAILED DESCRIPTION

Embodiments of the present disclosure are explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

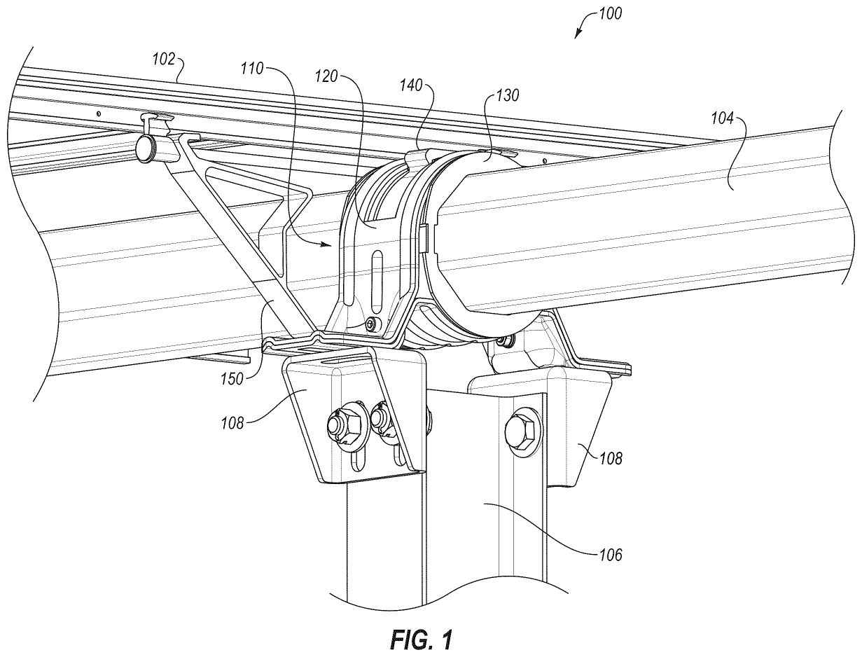

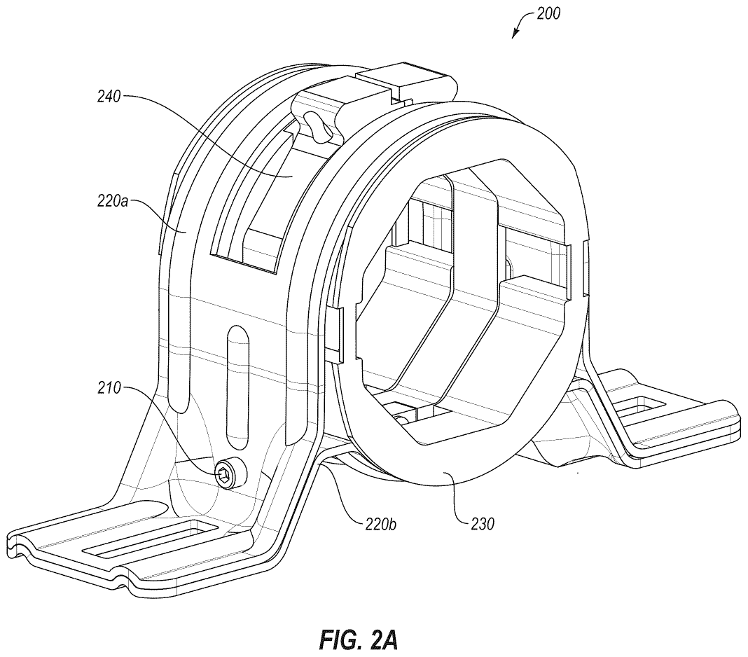

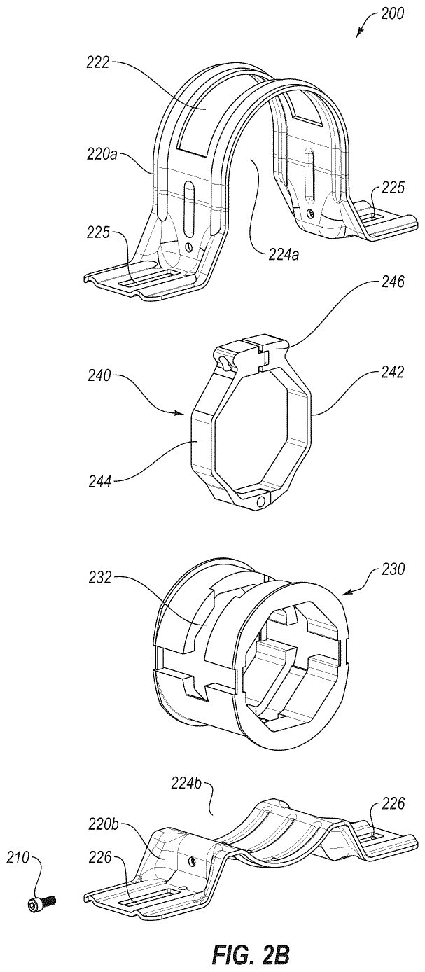

FIG. 1 illustrates an example system 100 for mounting PV modules. The example system 100 may include a photovoltaic (PV) module 102, a torque tube 104, a support structure or pile 106, pile brackets 108, a torque tube interface 110, and module brackets 150. The pile brackets 108 may be secured to the pile 106 through one or more mounting slots that allow the pile brackets 108 to be movable up and down relative to the position of the torque tube interface 110 and the pile 106. Similarly, the tops of the pile brackets 108 may also include mounting slots extending in one direction while corresponding mounting slots on the torque tube interface 110 (shown in FIGS. 2A and 2B) may extend in a substantially opposite direction to allow greater flexibility in positioning the torque tube interface 110 relative to the pile 106. In some embodiments, the mounting slots on the torque tube interface 110 extend in the same direction as the mounting slots on the pile brackets 108. In some embodiments, the pile 106 may also include mounting slots that correspond with the mounting slots on the pile brackets 108 to provide a similar level of adjustability.

The torque tube interface 110 may include a bearing housing 120, a bearing 130, and a bifurcated stop 140 (bifurcation not shown). The bearing housing 120 and the bearing 130 may define a housing slot and a bearing slot, respectively. The bearing housing 120 may be fixedly coupled to the pile 106 via the pile brackets 108 and the bearing 130 may be fixedly coupled to the torque tube 104. The bearing housing 120 may define an aperture (not shown), which the bearing 130 may be positioned substantially within such that the bearing 130 is able to rotate within the bearing housing 120 but is prevented from lateral movement relative to the bearing housing 120. Allowing the bearing 130 to rotate within the bearing housing 120 also allows rotational movement of the torque tube 104 relative to the pile 106. Permitting rotation of the torque tube 104 within the bearing housing 120 allows the PV module 102, which may be fixedly coupled to the torque tube 104 through the module bracket 150, to rotate with the torque tube 104 in order to track the position of the Sun as it moves across the sky. In some embodiments, a plurality of PV modules may be fixedly coupled to the torque tube 104 in the manner shown in the example system 100.

The ability of the bearing 130 to rotate may be limited by the bifurcated stop 140, which may include a first ring portion, a second ring portion, and a limiter. The first ring portion and the second ring portion may connect to define an enclosed ring that may be secured around the torque tube 104. The first and second ring portions may be positioned at least partially within the bearing housing 120. The limiter may extend through the housing and the bearing slots in order to limit the rotation of the torque tube 104 within the bearing housing 120. For example, the limiter may rotate in the clockwise direction until the limiter contacts the bearing housing 120 at one end of the housing slot at which point further rotation of the torque tube 104 may be inhibited. Additionally or alternatively, the limiter may rotate in the counter-clockwise direction until the limiter contacts the bearing housing 120 at another end of the housing slot at which point further rotation of the torque tube 104 may be inhibited.

Modifications, additions, or omissions may be made to the system 100 without departing from the scope of the present disclosure. For example, the designations of different elements in the manner described is meant to help explain concepts herein and is not limiting. Further, the system may include any number of other elements or may be implemented within other systems or contexts than those described. For example, in some embodiments, the enclosed ring defined by the first ring and the second ring may be positioned completely within the bearing housing. Additionally, in some embodiments, the bearing housing 120 and/or the bearing 130 may be separated into two or more pieces so that, like the bifurcated stop 140, each may also be removed from the torque tube 104 at any point on the torque tube 104.

FIGS. 2A and 2B respectively illustrate a perspective view and an exploded view of an example torque tube interface 200 unsecured from the support pile and the torque tube. The torque tube interface 200 of FIGS. 2A and 2B may be similar to, may perform similar functions as, and may utilize similar components to the torque tube interface 110 described with reference to FIG. 1. The torque tube interface 200 may include a bearing housing 220, a bearing 230, and a bifurcated stop 240. As shown in FIGS. 2A and 2B, the bearing housing 220 may be a bifurcated bearing housing including a first portion 220a and a second portion 220b. In some embodiments, the bearing housing 220 may be unitary. As shown in FIGS. 2A-2B, the bearing 230 may be a unitary bearing. In some embodiments, the bearing 230 may also be bifurcated.

The first portion 220a of the bearing housing 220 may define a housing slot 222, which a limiter 246 of the bifurcated stop 240 may extend through in order to limit the amount that a torque tube may rotate within the bearing housing 220. The bearing housing 220 may also define an aperture 224. As shown in FIG. 2B, the first portion of the bearing housing 220a may define a first portion of the aperture 224a and the second portion of the bearing housing 220b may define a second portion of the aperture 224b such that when the first portion of the bearing housing 220a and the second portion of the bearing housing 220b are secured together the aperture 224 is defined in whole. The first portion of the bearing housing 220a may be secured to the second portion of the bearing housing 220b with a set screw 210. However, other methods and mechanisms may be used to secure the first portion of the bearing housing 220a to the second portion of the bearing housing 220b. For example, the first portion of the bearing housing 220a may be secured to the second portion of the bearing housing 220b via a bolt, a pin, a dowel, a clamp, an adhesive, a collar, a detent mechanism, a magnet, or any other method of securing the first portion of the bearing housing 220a to the second portion of the bearing housing 220b.

The first portion of the bearing housing 220a may also include a first mounting slot 225 and the second portion of the bearing housing 220b may include a second mounting slot 226. As discussed in the description of FIG. 1, the first mounting slot 225 and the second mounting slot 226 may allow the torque tube interface 200 to be secured to a pile (such as the pile 106) via the use of brackets (such as the pile brackets 108). Additionally, the first mounting slot 225 and the second mounting slot 226 may allow a PV module (such as the PV module 102) to be coupled to the torque tube interface 200 via a module bracket (such as the module bracket 150). In some embodiments and as illustrated in FIGS. 2A and 2B, the first portion of the bearing housing 220a and the second portion of the bearing housing 220b may include multiple mounting slots. For example, the first portion of the bearing housing 220a may include multiple first mounting slots 225 and the second portion of the bearing housing 220b may include multiple second mounting slots 226.

The bearing housing 220 may be manufactured from any suitable material, including but not limited to plastic or a metal, such as aluminum and steel. In some embodiments, sheets of pre-treated metal, such as galvanized steel, may be used which may allow for more robust components and/or greater flexibility in manufacturing and cost savings in manufacturing. Additionally or alternatively, such a material may allow for low-friction coatings to be applied to the steel prior to the forming process, thereby reducing cost.

The bearing 230 may be positioned substantially within the aperture 224 defined by the bearing housing 220 such that the bearing 230 is able to rotate within the bearing housing 220. The bearing 230 may include a bearing slot 232, which the bifurcated stop 240 may be placed within.

The bifurcated stop 240 may include a first ring portion 242 and a second ring portion 244 which may connect to define an enclosed ring. The enclosed ring may be secured around a torque tube and positioned at least partially within the bearing housing 220. For example, the enclosed ring may be placed within the bearing slot 232 defined by the bearing 230 and the housing slot 222 defined by the bearing housing 220. However, because the bifurcated stop 240 is not unitary the bifurcated stop 240 may be uninstalled and replaced while only having to remove the PV module directly above the bifurcated stop 240 and without having to remove other components of a solar panel system including one or more other PV modules in a line of PV modules. Additionally, the bifurcated stop 240 may be uninstalled and replaced without having to slide the bifurcated stop 240 off the end of the torque tube because the bifurcated stop 240 is not unitary.

The bifurcated stop 240 may also include the limiter 246, which may extend through the housing slot 222 and the bearing slot 232 to limit the amount that the torque tube may rotate within the bearing housing 220. Ends of the housing slot 222 may represent the boundaries of rotation for the torque tube, and provide a point at which the limiter 246 may stop the rotation of the torque tube. For example, the torque tube may only be able to rotate 52 degrees in the positive (clockwise) direction and 52 degrees in the negative (counter-clockwise) directions. Thus, the limiter 246 may prevent rotation beyond 52 degrees in the positive direction and in the negative direction when the limiter 246 comes into contact with an end of the housing slot 222 in the positive and/or negative directions.

The bifurcated stop 240 may be manufactured from any suitable material, including but not limited to plastic, rubber, or a metal, such as steel, iron, or aluminum. In some embodiments, the bifurcated stop 240 may be manufactured from ferrous metals like steel and/or cast-iron. In some embodiments, torsional and axial force loads experienced at the torque tube interface may require that the bifurcated stop 240 be manufactured from steel and/or cast-iron.

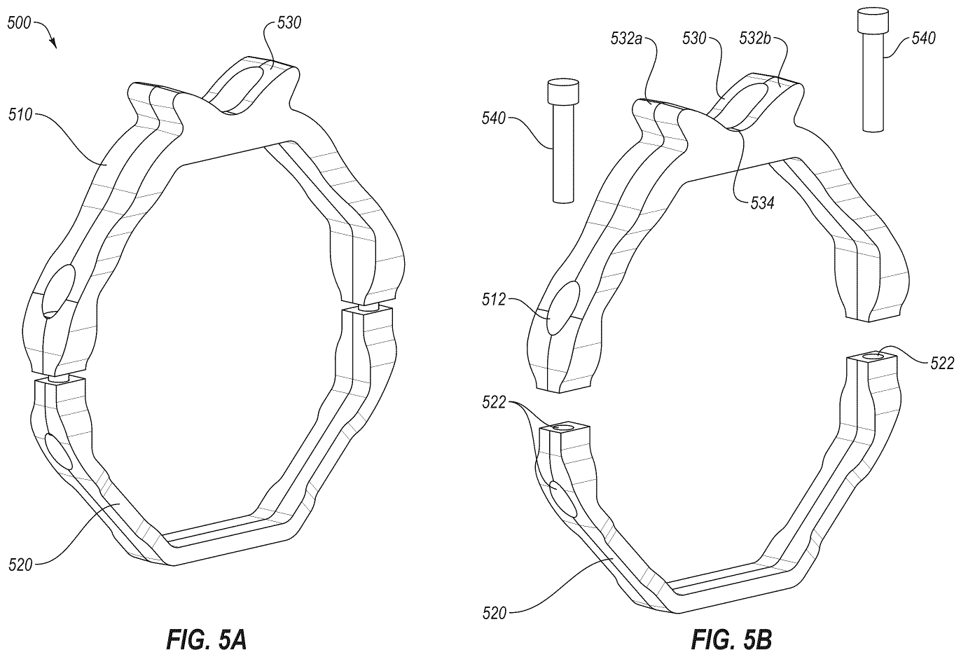

Modifications, additions, or omissions may be made to the example torque tube interface 200 without departing from the scope of the present disclosure. For example, the designations of different elements in the manner described is meant to help explain concepts herein and is not limiting. Further, the torque tube interface 200 may include any number of other elements or may be implemented within other systems or contexts than those described. For example, the bearing housing 220 may be unitary instead of bifurcated. Additionally or alternatively, the bearing 230 may be bifurcated instead of unitary and the bearing 230 may further include a first bearing portion and a second bearing portion. In addition, the bearing housing 220, the bearing 230, and or the bifurcated stop 240 may be bifurcated along any axis or angle. For example, the bifurcated stop 240 may be horizontally bifurcated or bifurcated at 45 degrees from horizontal instead of vertically bifurcated as shown in the Figures. For instance, a horizontally bifurcated stop is described in more detail with reference to FIGS. 5A and 5B.

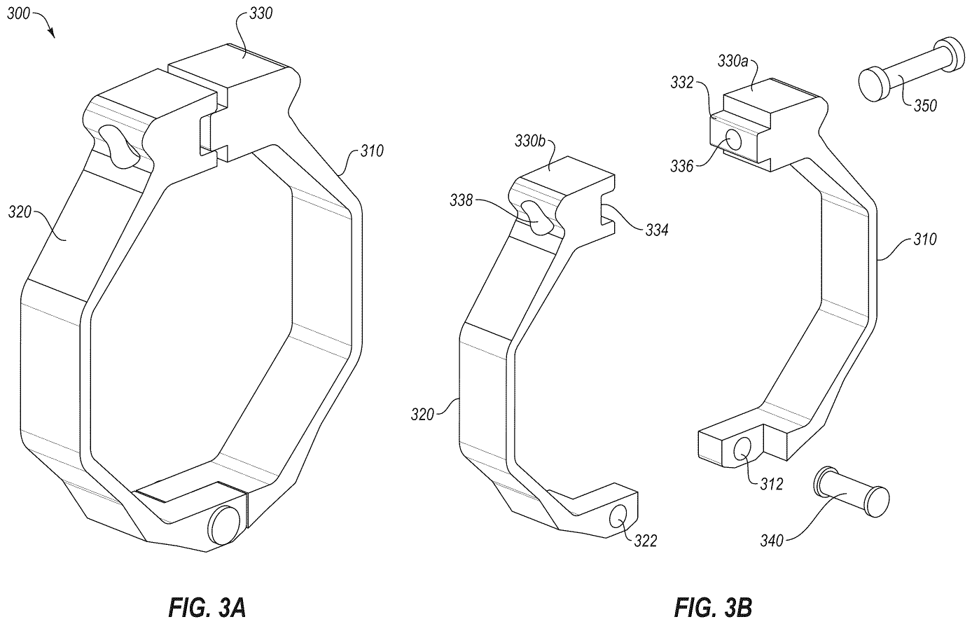

FIGS. 3A and 3B illustrate a perspective view of an example bifurcated stop 300 and an exploded view of the example bifurcated stop 300, respectively. The bifurcated stop 300 may be similar to, have similar components as, and perform similar functions as the bifurcated stops 140 of FIGS. 1 and 240 of FIGS. 2A and 2B. As shown in FIG. 3A, the bifurcated stop 300 may include a first ring portion 310 and a second ring portion 320, which may be connectable to define an enclosed ring that may be secured around a torque tube and positioned at least partially within a bearing housing. The bifurcated stop 300 may also include a limiter 330, which may be configured to extend through a housing slot in the bearing housing and bearing slot in a bearing in order limit the amount that the torque tube may rotate. For example, the bifurcated stop 300 may prevent the torque tube from over-rotating due to a rotational torque created by the overhanging weight of PV modules and/or external forces like wind, snow, and seismic activities.

In some embodiments, holes 312 and 322 may be defined by the distal ends of the first ring portion 310 and the second ring portion 320, respectively. In some embodiments, a hinge pin 340 may secure the distal end of the first ring portion 310 to the distal end of the second ring portion 320 through the holes 322 and 312. In some embodiments, the holes 322 and/or 312 may be through holes. Alternatively, the holes 322 and/or 312 may be blind holes. In some embodiments, the holes 322 and/or 312 may be threaded. Alternatively, the holes 322 and/or 312 may be unthreaded.

In some embodiments, the limiter 330 may include a first side 330a and a second side 330b. The first side 330a may be positioned at a proximal end of the first ring portion 310, and the second side 330b may be positioned at a proximal end of the second ring portion 320. In some embodiments, the first side 330a and the second side 330b may define holes 336 and 338, respectively, through which a fastener 350 may secure the proximal end of the first ring portion 310 with the proximal end of the second ring portion 320. The fastener 350 may be a pin, a bolt, a dowel, a magnet, or any other fastener. In some embodiments, the holes 336 and/or 338 may be through holes. Alternatively, the holes 336 and/or 338 may be blind holes. In some embodiments, the holes 336 and/or 338 may be threaded. Alternatively, the holes 336 and/or 338 may be unthreaded.

The fastener 350 may allow the bifurcated stop 300 to be adjustably tightened around the torque tube. For example, a circumference of an aperture defined by the enclosed ring created by the first and second ring portions 310 and 320 may be slightly smaller than a circumference of an outer surface of a torque tube such that the tightening the fastener 350 may create a tighter fit of the enclosed ring around the torque tube and loosening the fastener 350 may create a looser fit. Thus, the fastener 350 may allow for the omission of set screws that apply a pressure directly to a torque tube that are typically utilized to perform a similar function in unitary stop designs.

In these and other embodiments, the first side 330a may include a tab 332 and the second side 330b may include a recess 334 into which the tab 332 may fit when the first ring portion 310 and the second ring portion 320 are in an attached configuration defining an enclosed ring. The tab 332 and/or recess 334 may take on some of the shear and/or torsional forces experienced at the fastener 350 and thereby reduce the shear and/or torsional forces experienced at the fastener 350. In some embodiments, the tab 332 may be a tongue and the recess 334 may be a groove. In some embodiments, the tab 332 may be a peg and the recess 334 may be an opening having a shape and size to receive the peg. For example, the tab 332 may be a round peg and the recess 334 may be a round hole that is shaped and sized to receive the round peg. In other embodiments, the tab 332 and recess 334 may respectively be a tail and pin, rivet and hole, key and keyseat, or any other male-female combination which may fit together when the first ring portion 310 and the second ring portion 320 are in an attached configuration. In some embodiments, the recess 334 may have a depth greater than or equal to the length of the tab 332 such that the tab 332 may be fully inserted into the recess 334. Alternatively, the recess 334 may have a depth lesser than the length of the tab 332. In some of these embodiments, the tab 332 may contact a bottom depth of the recess 334 before the tab 332 is fully inserted into the recess 334, which may provide clearance between the bifurcated stop 300 and the torque tube. The clearance between the bifurcated stop 300 and the torque tube may allow the torque tube to thermally expand within the bifurcated stop 300.

Modifications, additions, or omissions may be made to the example bifurcated stop 300 without departing from the scope of the present disclosure. For example, the designations of different elements in the manner described is meant to help explain concepts herein and is not limiting. Further, the bifurcated stop 300 may include any number of other elements or may be implemented within other systems or contexts than those described. In some embodiments, the first side 330a and the second side 330b of the limiter 330 may include multiple tabs and multiple recesses. For example, the first side 330a may include a first tab and a second tab and the second side 330b may include a first recess and a second recess. The first tab may fit into the first recess and the second tab may fit into the second recess when the first ring portion 310 and the second ring portion 320 are in an attached configuration. In these and other embodiments, multiple fasteners 350 may also be included. Additionally or alternatively, the distal end of the first ring portion 310 and the distal end of the second ring portion 320 may utilize a tab-and-recess configuration. In some embodiments, the limiter 330 may be a part of either the first ring portion 310 or the second ring portion 320 instead of split into a first side 330a and a second side 330b of the bifurcation. For example, a bifurcated stop that includes the limiter as part of the first ring portion is described with reference to FIGS. 5A and 5B. In some embodiments, the bifurcated stop 300 may be bifurcated horizontally or at any other angle instead of vertically as shown in FIGS. 3A and 3B. For instance, a horizontally bifurcated stop is described in more detail with reference to FIGS. 5A and 5B.

In addition, while the holes 336 and 338 that receive the fastener 350 are within the tab 332 and recess 334 components, in other embodiments, holes that receive a fastener may be separated from a tab and recess feature.

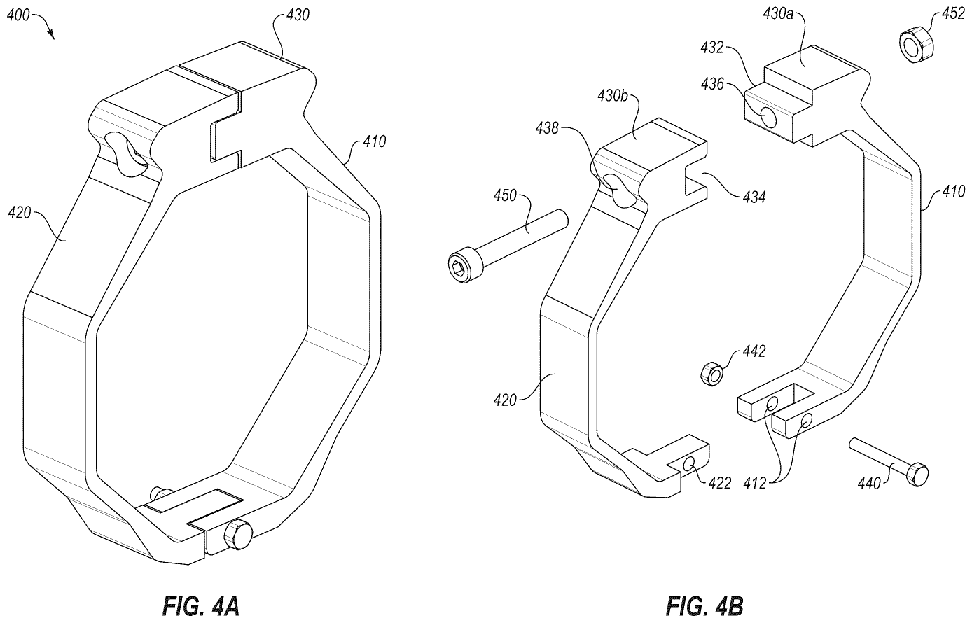

FIGS. 4A and 4B illustrate a perspective view of an example bifurcated stop 400 and an exploded view of the example bifurcated stop 400, respectively. The bifurcated stop 400 may be similar to, have similar components as, and perform similar functions as the bifurcated stop 140 of FIG. 1, the bifurcated stop 240 of FIGS. 2A and 2B and the bifurcated stop 300 of FIGS. 3A and 3B. For example, the bifurcated stop 400 may include a first ring portion 410, a second ring portion 420, and a limiter 430, all of which may be similar as, function similar to, and utilize similar components as the first ring portion 310, the second ring portion 320, and the limiter 330 described with reference to FIGS. 3A and 3B.

The distal end of the first ring portion 410 may include a female end which may define one or more holes 412. The distal end of the second ring portion 420 may include a male end which may define one or more holes 422. The male end may be inserted into the female end such that the one or more holes 412 and the one or more holes 422 align. A first fastener 440 may be inserted through the aligned holes and may be secured with a first mating component 442. In some embodiments, the first fastener 440 may be a bolt and the first mating component 442 may be a nut. In some embodiments, the first fastener 440 may be a hinge pin. In some embodiments, the one or more holes 412 and 422 may be threaded such that the first fastener 440 threads into the holes 412 and 422 and the first mating component 442 threads onto the first fastener 440 to secure it in place.

In some embodiments, the limiter 430 may include a first side 430a and a second side 430b. The first side 430a may be positioned at a proximal end of the first ring portion 410, and the second side 430b may be positioned at a proximal end of the second ring portion 420. In some embodiments, the first side 430a and the second side 430b may define holes 436 and 438, respectively, through which a second fastener 450 may secure the proximal end of the first ring portion 410 with the proximal end of the second ring portion 420. A second mating component 452 may be included to secure the second fastener 450 in place. In some embodiments, the second fastener 450 may be a bolt and the second mating component 452 may be a nut. In some embodiments, the second fastener 450 may be a hinge pin. In some embodiments, the holes 436 and/or 438 may be through holes. Alternatively, the holes 436 and/or 438 may be blind holes. In some embodiments, the holes 436 and/or 438 may be threaded. Alternatively, the holes 436 and/or 438 may be unthreaded. As shown, the fastener 450 may be inserted through the hole 438 and connect the second ring portion 420 to the first ring portion 410 through the hole 436. The mating component 452 may then be secured to the fastener 450 in order to prevent it from moving out of the holes 436 and/or 438.

The fastener 450 may allow the bifurcated stop 400 to be adjustably tightened around the torque tube. For example, a circumference of an aperture defined by the closed ring created by the first and second ring portions 410 and 420 may be slightly smaller than a circumference of an outer surface of a torque tube such that the tightening the fastener 450 may create a tighter fit of the enclosed ring around and a friction attachment with the torque tube and loosening the fastener 450 may create a looser fit. In some embodiments, where the cross-sectional shape of the torque tube is a polygon, one or more of the sides defined by the bifurcated stop 400 may be smaller than the corresponding side on the torque tube. In one embodiment, the sides that join the bifurcated stop 400 may be slightly smaller than the corresponding side length of the torque tube. Thus, the fastener 450 may allow for the omission of set screws that apply a pressure directly to a torque tube that are typically utilized to perform a similar function in unitary stop designs.

In these and other embodiments, the first side 430a may include a tab 432 and the second side 430b may include a recess 434 into which the tab 432 may fit when the first ring portion 410 and the second ring portion 420 are in an attached configuration defining an enclosed ring. The tab 432 and/or recess 434 may take on some of the shear and/or torsional forces experienced at the fastener 450 and thereby reduce the shear and/or torsional forces experienced at the fastener 450. In some embodiments, the tab 432 may be a tongue and the recess 434 may be a groove. In some embodiments, the tab 432 may be a peg and the recess 434 may be an opening having a shape and size to receive the peg. For example, the tab 432 may be a round peg and the recess 434 may be a round hole that is shaped and sized to receive the round peg. In other embodiments, the tab 432 and recess 434 may respectively be a tail and pin, rivet and hole, key and keyseat, or any other male-female combination which may fit together when the first ring portion 410 and the second ring portion 420 are in an attached configuration. In some embodiments, the recess 434 may have a depth greater than or equal to the length of the tab 432 such that the tab 432 may be fully inserted into the recess 434. Alternatively, the recess 434 may have a depth lesser than the length of the tab 432. In some of these embodiments, the tab 432 may contact a bottom depth of the recess 434 before the tab 432 is fully inserted into the recess 434, which may provide clearance between the bifurcated stop 400 and a torque tube. The clearance between the bifurcated stop 400 and the torque tube may allow the torque tube to thermally expand within the bifurcated stop 400.

Modifications, additions, or omissions may be made to the example bifurcated stop 400 without departing from the scope of the present disclosure. For example, the designations of different elements in the manner described is meant to help explain concepts herein and is not limiting. Further, the bifurcated stop 400 may include any number of other elements or may be implemented within other systems or contexts than those described. In some embodiments, the first and second mating components 442 and/or 452 may be omitted and the first and second fasteners 440 and/or 450 may connect each end of the first ring portion 410 and the second ring portion 410. For example, the first fastener 440 may be a hinge pin and the first mating component 442 may be omitted.

FIGS. 5A and 5B illustrate a perspective view of an example bifurcated stop 500 and an exploded view of the example bifurcated stop 500, respectively. The bifurcated stop 500 may be similar to, have similar components as, and perform similar functions as the bifurcated stops described throughout the present disclosure. For example, the bifurcated stop 500 may include a first ring portion 510, a second ring portion 520, and a limiter 530, all of which may be similar as, function similar to, and utilize similar components as the similarly described features throughout the present disclosure.

As shown in FIG. 5A, the first ring portion 510 and the second ring portion 520 may be connectable to define an enclosed ring that may be secured around a torque tube and positioned at least partially within a bearing housing. The limiter 530 may be configured to extend through a housing slot in the bearing housing and bearing slot in a bearing in order limit the amount that the torque tube may rotate. For example, the bifurcated stop 530 may prevent the torque tube from over-rotating due to a rotational torque created by the overhanging weight of PV modules and/or external forces like wind, snow, and seismic activities.

In some embodiments, the bifurcated stop 500 may be bifurcated such that the limiter 530 may be only included in one of the first ring portion 510 or the second ring portion 520. For example, as illustrated in FIGS. 5A and 5B, the bifurcated stop 500 may be bifurcated horizontally such that the first ring portion 510 includes the entirety of the limiter 530.

In some embodiments, the limiter 530 may be symmetrically shaped. For example, as illustrated in FIGS. 5A and 5B, a first side of the limiter 530 may include a first raised portion 532a (e.g., a first ear), a second side of the limiter 530 may include a second raised portion 532b (e.g., a second ear) and the middle of the limiter 530 may include a depression 534 (e.g., a valley) between the raised portions 532. In these and other embodiments, the configuration of the first raised portion 532a, the depression 534, and the second raised portion 532b may allow the overall material used in the limiter 530 to be reduced.

In some embodiments, the first ring portion 510 may include holes 512 on one or both sides of the first ring portion 510, and the second ring portion 520 may include holes 522 on one or both sides of the second ring portion 520, respectively, through which a fastener 540 may secure the first ring portion 510 and the second ring portion 520. For example, the holes 512 of the first ring portion 510 and the holes 522 of the second ring portion 520 may be aligned and a fastener 540 may couple the first ring portion 510 and the second ring portion 520 through each set of aligned holes. The fastener 540 may be a pin, a bolt, a dowel, a magnet, or any other fastener. In some embodiments, the holes 512 and/or 522 may be through holes. Alternatively, the holes 512 and/or 522 may be blind holes. In some embodiments, the holes 512 and/or 522 may be threaded. Alternatively, the holes 512 and/or 522 may be unthreaded.

In these and other embodiments, because the fastener 540 is vertically oriented due to the horizontal bifurcation of the bifurcated stop 500, the bifurcated stop 500 may be thinner than bifurcated stops that are vertically bifurcated and are coupled with a fastener that is horizontally oriented. Consequently, in these instances, the form factor of the bifurcated stop 500 may be reduced, which may allow for less materials to be used in the manufacturing of the bifurcated stop 500. In these and other embodiments, the reduction of the form factor of the bifurcated stop 500 may also allow reduction in size of the bearing slot and/or housing slot, which may reduce the form factor of the bearing and bearing housings.

The fastener 540 may allow the bifurcated stop 500 to be adjustably tightened around the torque tube. For example, a circumference of an aperture defined by the enclosed ring created by the first and second ring portions 510 and 520 may be slightly smaller than a circumference of an outer surface of a torque tube such that the tightening the fastener 540 may create a tighter fit of the enclosed ring around the torque tube and loosening the fastener 540 may create a looser fit. In some embodiments, where the cross-sectional shape of the torque tube is a polygon, one or more of the sides defined by the bifurcated stop 500 may be smaller than the corresponding side on the torque tube. In one embodiment, the sides that join the bifurcated stop 500 may be slightly smaller than the corresponding side length of the torque tube. Thus, the fastener 540 may allow for the omission of set screws that apply a pressure directly to a torque tube that are typically utilized to perform a similar function in unitary stop designs.

Modifications, additions, or omissions may be made to the example bifurcated stop 500 without departing from the scope of the present disclosure. For example, the designations of different elements in the manner described is meant to help explain concepts herein and is not limiting. Further, the bifurcated stop 500 may include any number of other elements or may be implemented within other systems or contexts than those described. While the limiter 530 is illustrated as having a specific configuration, it will be appreciated that other symmetric and/or asymmetric configurations may be used other than that illustrated in FIG. 5A to allow the limiter to inhibit rotation of the torque tube and to reduce material cost.

The various features illustrated in the drawings may be, but are not necessarily, drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” among others).

Relative terms used in the present disclosure and especially in the appended claims (e.g., bodies of the appended claims) are generally intended as falling within manufacturing tolerances and/or within scope reasonably understood by a person of skill in the art. For example, if two components are identified as being the “same” size, there may be variations consistent with manufacturing variances. Terms describing “approximately,” “similar,” “substantially,” or other terms designating similarity may convey within ten percent of the comparative value. For example, two components that are approximately the same size would be understood to be of a size within ten percent of each other.

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

1. A torque tube interface for securing a torque tube to a support pile in a photovoltaic (PV) system, the torque tube interface comprising:
a bearing housing configured to be secured to a support pile, wherein the bearing housing defines an aperture and a housing slot;
a bearing configured to be secured to a torque tube, wherein the bearing is positioned substantially within the aperture defined by the bearing housing such that the bearing is able to rotate within the bearing housing, the bearing defining a bearing slot; and
a bifurcated stop comprising a first ring portion, a second ring portion, and a limiter, wherein:
the first and second ring portions are connectable to define an enclosed ring that is configured to be secured around the torque tube and be positioned at least partially within the bearing housing, and
the limiter is configured to extend through the housing slot and the bearing slot to limit an amount that the torque tube is allowed to rotate within the bearing housing.

2. The torque tube interface of claim 1, wherein distal ends of the first and second ring portions define holes through which a hinge pin is configured to secure the distal end of the first ring portion with the distal end of the second ring portion.

3. The torque tube interface of claim 1, wherein a first side of the limiter is positioned at a proximal end of the first ring portion and a second side of the limiter is positioned at a proximal end of the second ring portion.

4. The torque tube interface of claim 3, wherein the first side of the limiter includes a tab and the second side of the limiter defines a recess into which the tab is configured to fit when the first and second ring portions are in an attached configuration.

5. The torque tube interface of claim 4, wherein the tab is a tongue and the recess is a groove.

6. The torque tube interface of claim 1, wherein the limiter is included only in the first ring portion or only in the second ring portion.

7. The torque tube interface of claim 3, wherein the first and second sides of the limiter define holes through which a fastener is configured to secure the proximal end of the first ring portion with the proximal end of the second ring portion.

8. The torque tube interface of claim 7, wherein a size of the enclosed ring defined by the bifurcated stop is smaller than an exterior size of the torque tube such that a friction attachment between the bifurcated stop and the torque tube is created by a tightening action on the fastener.

9. The torque tube interface of claim 1, wherein the bearing housing is bifurcated and includes a first housing portion and a second housing portion.

10. The torque tube interface of claim 1, wherein the bearing is bifurcated and includes a first bearing portion and a second bearing portion.

11. The torque tube interface of claim 1, wherein the bifurcated stop is constructed from cast-iron.

12. The torque tube interface of claim 1, wherein the bifurcated stop is horizontally bifurcated.

13. The torque tube interface of claim 1, wherein the bifurcated stop is vertically bifurcated.

14. The torque tube interface of claim 1, wherein the limiter includes a first raised portion at a first side and a second raised portion at a second side.

15. A bifurcated stop comprising:
a first ring portion;
a second ring portion configured to be connected with the first ring portion such that the first ring portion and the second ring portion define an enclosed ring that is configured to be secured around a torque tube and positioned at least partially within a bearing housing; and
a limiter included in one or both of the first ring portion or the second ring portion, the limiter configured to limit an amount that the torque tube is allowed to rotate within the bearing housing.

16. The bifurcated stop of claim 15, wherein the bifurcated stop is vertically bifurcated.

17. The bifurcated stop of claim 16, wherein the bifurcated stop is horizontally bifurcated.

18. The bifurcated stop of claim 15, wherein a first side of the limiter is included in the first ring portion and a second side of the limiter is included in the second ring portion, such that the limiter is formed when the first ring portion and the second ring portion are connected.

19. The bifurcated stop of claim 15, wherein the limiter is included in only the first ring portion or only the second ring portion.

20. The bifurcated stop of claim 15, wherein a size of the enclosed ring defined by the first ring portion and the second ring portion is configured to be smaller than an exterior size of the torque tube.
